(19) United States
(12) Patent Application Publication
(10) Pub. No.: US 2024/0144050 A1
(43) Pub. Date: May 2, 2024

(54) STACKED MACHINE LEARNING MODELS FOR TRANSACTION CATEGORIZATION

(71) Applicant: Intuit Inc., Mountain View, CA (US)

(72) Inventors: Wei Wang, San Jose, CA (US); Mu Li, Redwood City, CA (US); Yue Yu, Mountain View, CA (US); Kun Lu, Saratoga, CA (US); Rohini R. Mamidi, San Jose, CA (US); Nazanin Zaker Habibabadi, Sunnyvale, CA (US); Selvam Raman, San Jose, CA (US)

(73) Assignee: Intuit Inc., Mountain View, CA (US)

(21) Appl. No.: 17/977,961

(22) Filed: Oct. 31, 2022

(51) Int. Cl. G06N 5/04

(52) U.S. Cl. CPC G06N 5/04

(57) ABSTRACT

A two-stage machine learning model is used to for categorization of a dataset, such as transactions. A plurality of complementary base machine learning models are used to generate initial inference results and associated measures of inference confidence from the dataset, which are collected as a meta dataset. Each of the complementary models is associated with a different part of the dataset in which it has a higher accuracy in that part than the other models. The meta dataset is provided as input to a meta machine learning model, which is trained to produce a final inference result, and a confidence score model, which is trained to produce a confidence score associated with the final inference result.

### TECHNICAL FIELD

This disclosure relates generally to machine learning models, and in particular to techniques and systems for combining machine learning models and measure of learning confidence.

### DESCRIPTION OF RELATED ART

Machine learning is a form of artificial intelligence that uses algorithms to use data as input to predict new output values. Machine learning, for example, may be used in a wide variety of tasks, including data categorization, natural language processing, financial analysis, image processing, generating recommendations, spam filtering, fraud detection, malware threat detection, business process automation (BPA), etc. In general, machine learning uses training examples to train a model to map inputs to outputs. Once trained, a machine learning model may be used to accurately predict outcomes from new, previously unseen data.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter. Moreover, the systems, methods, and devices of this disclosure each have several innovative aspects, no single one of which is solely responsible for the desirable features disclosed herein.

A two-stage machine learning model is discussed herein for use to categorize a dataset, such as transactions. The two-stage machine learning model includes a plurality of complementary base machine learning models. Each of the complementary models is associated with a different part of the dataset in which it has a higher accuracy in that part than the other models. The complementary models generate initial inference results and associated measures of inference confidence from the dataset, which are collected as a meta dataset. The meta dataset is provided as input to a meta machine learning model, which is trained to produce a final inference result. The meta dataset is also provided to a confidence score model, which is trained to produce a confidence score associated with the final inference result.

In one implementation, an aspect of the subject matter described in this disclosure can be implemented as a computer-implemented method. An example method includes obtaining a dataset comprising transaction data and generating inference results and associated measures of inference confidence from a plurality of complementary machine learning models based on the dataset, wherein each machine learning model in the plurality of complementary machine learning models is associated with a different part of the dataset and has a higher accuracy in an associated part than other machine learning models in the plurality of complementary machine learning models. The method includes collecting the inference results and the associated measures of inference confidence from the plurality of complementary machine learning models in a meta dataset. The method further includes generating final inference results comprising categorized transactions from a trained meta machine learning model based on the meta dataset, generating final confidences associated with the final inference results from a trained confidence score model based on the meta dataset and the final inference results, and reporting the final inference results and associated final confidences.

In one implementation, an aspect of the subject matter described in this disclosure can be implemented a system for categorizing transactions. The system may include one or more processors, and a memory coupled to the one or more processors and storing instructions that, when executed by the one or more processors, cause the system to perform operations. The system, for example, may be caused to obtain a dataset comprising transaction data and generate inference results and associated measures of inference confidence from a plurality of complementary machine learning models based on the dataset, wherein each machine learning model in the plurality of complementary machine learning models is associated with a different part of the dataset and has a higher accuracy in an associated part than other machine learning models in the plurality of complementary machine learning models. The system may be caused to collect the inference results and the associated measures of inference confidence from the plurality of complementary machine learning models in a meta dataset. The system may further be caused to generate final inference results comprising categorized transactions from a trained meta machine learning model based on the meta dataset, generate final confidences associated with the final inference results from a trained confidence score model based on the meta dataset and the final inference results, and report the final inference results and associated final confidences.

In one implementation, an aspect of the subject matter described in this disclosure can be implemented as a computer-implemented method. An example method includes obtaining a training dataset comprising transaction data and training a plurality of complementary machine learning models based on the training dataset, wherein each machine learning model in the plurality of complementary machine learning models is associated with a different part of the training dataset and has a higher accuracy in an associated part than other machine learning models in the plurality of complementary machine learning models, wherein each machine learning model in the plurality of complementary machine learning models is trained to infer prediction results and associated measures of prediction confidence. The method may include collecting prediction results and associated measures of prediction confidences from the plurality of complementary machine learning models in a meta training dataset. The method may further include training a meta machine learning model based on the meta training dataset to infer final prediction results comprising categorized transactions, training a confidence score model based on the meta training dataset and the final prediction results to generate measures of final prediction confidences associated with the final prediction results, and storing trained model artifacts comprising the final prediction results and the measures of final prediction confidences and the prediction results and associated measures of prediction confidences from each of the plurality of complementary machine learning models.

In one implementation, an aspect of the subject matter described in this disclosure can be implemented as a system for categorizing transactions. The system may include one or more processors, and a memory coupled to the one or more processors and storing instructions that, when executed by the one or more processors, cause the system to perform operations. The system, for example, may be caused to obtain a training dataset comprising transaction data and train a plurality of complementary machine learning models based on the training dataset, wherein each machine learning model in the plurality of complementary machine learning models is associated with a different part of the training dataset and has a higher accuracy in an associated part than other machine learning models in the plurality of complementary machine learning models, wherein each machine learning model in the plurality of complementary machine learning models is trained to infer prediction results and associated measures of prediction confidence. The system may be caused to collect prediction results and associated measures of prediction confidences from the plurality of complementary machine learning models in a meta training dataset. The system may be further caused to train a meta machine learning model based on the meta training dataset to infer final prediction results comprising categorized transactions, train a confidence score model based on the meta training dataset and the final prediction results to generate measures of final prediction confidences associated with the final prediction results, and store trained model artifacts comprising the final prediction results and the measures of final prediction confidences and the prediction results and associated measures of prediction confidences from each of the plurality of complementary machine learning models.

### BRIEF DESCRIPTION OF THE DRAWINGS

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

FIG. 1 shows a block diagram of a system to configured to categorize transactions based on a stacked machine learning models including a plurality of base learners, a meta learner, and a confidence score model, according to some implementations.

FIG. 2 shows an illustrative architecture of a framework for model stacking including a plurality of base learners, a meta learner, and a confidence score model, according to some implementations.

FIG. 3 shows an illustrative process for offline training of stacked models including a plurality of base learners, a meta learner, and a confidence score model.

FIG. 4 shows an illustrative example of a multilayer perceptron model that may be used as a base learner, according to some implementations.

FIG. 5 shows an illustrative process for inference using stacked models including a plurality of base learners, a meta learner, and a confidence score model.

FIG. 6 shows an illustrative flowchart depicting an example operation for training stacked machine learning models, according to some implementations

FIG. 7 shows an illustrative flowchart depicting an example operation for inference using stacked machine learning models, according to some implementations. Like reference numbers and designations in the various drawings indicate like elements.

### DETAILED DESCRIPTION

The following description is directed to certain implementations for categorization of datasets and, in particular, to categorization of transaction attributes based on machine learning models. Any type of transaction is contemplated herein, including business transactions, financial transactions, non-financial transactions, or any other type of transaction which may include multiple attributes to be categorized. The transaction attributes may include, for example, user, transaction description, payee, time, amount, and other metadata from the institution. It may be readily understood that certain aspects of the disclosed systems and methods can be arranged and combined in a wide variety of different configurations, applications, and use cases, all of which are contemplated herein.

Accuracy in the categorization of transactions attributes may be particularly important to properly assess the quality or other characteristics of an entity associated with the transactions. In one example, it may be desirable to assess the risk profile or other quality of a business, business sector, person, event, etc., based on a collected dataset of previous transactions. The transaction information may be obtained from one or more sources and may include a plurality of attributes, including entity specific data, third party specific data (such as institution data, payee data etc.), and transaction related data, such as time, amount, location, etc. Assessment of the risk profile or other quality of a business, business sector, person, event may be based on an acquired dataset of transactions. However, mischaracterization or omission of attributes of the transactions in the acquired dataset may have a detrimental impact on the accuracy of any assessment of the dataset that is to be performed. Accordingly, accuracy and coverage in categorization of transaction attributes in a dataset is desirable.

There are many choices of model types for transaction categorization (multi-class classification model). For example, the categorization of a dataset may be treated as a multi-class classification machine learning model, where the input data is from the transaction attributes. However, each individual classifier performs differently in terms of accuracy and coverage and may not provide the desired accuracy and coverage over the full dataset.

The disclosed implementations provide an approach to categorization of transactions using a two-stage learning process. A first stage (base learning) includes a plurality of complementary machine learning models, sometimes referred to as base leaners, with each base learner associated with a different part of the dataset and having a higher accuracy in the associated part than the other base learners. The base learners are trained to utilize raw transaction data to infer prediction results along with a measure of prediction confidence. The prediction results from all of the base learners are collected and stored as a separate meta dataset. A second stage (meta learning) includes a meta machine learning model that is trained to receive the meta dataset as a model input, and to generate a final prediction, along with a final confidence score, e.g., that may be on a zero to one probability scale.

In this manner, the base learning layer may be developed using a combination of different and complementary machine learning models, such as one or more recommender based models and one or more neural network based classification models to use the raw transaction data with desired accuracy and coverage. Moreover, by leveraging model stacking with the base learning layer and meta learning layer, several individual base learners, which are each relatively weak (in terms of accuracy and coverage) may be combined to build a strong learning layer, and the meta learning layer is independent of the raw transaction data, which includes a large amounts of text data that is inherently noisy and potentially increases classification errors. Further, the final confidence score is generated by combining heterogeneous confidence measures obtained from the plurality of base learners, which is faster to compute relative to a conventional approach of estimating the exact (or approximate) distribution of predictions (e.g., bootstraping).

In the following description, numerous specific details are set forth such as examples of specific components, circuits, and processes to provide a thorough understanding of the present disclosure. The term “coupled” as used herein means connected directly to or connected through one or more intervening components or circuits. The terms “processing system” and “processing device” may be used interchangeably to refer to any system capable of electronically processing information. Also, in the following description and for purposes of explanation, specific nomenclature is set forth to provide a thorough understanding of the aspects of the disclosure. However, it will be apparent to one skilled in the art that these specific details may not be required to practice the example implementations. In other instances, well-known circuits and devices are shown in block diagram form to avoid obscuring the present disclosure. Some portions of the detailed descriptions which follow are presented in terms of procedures, logic blocks, processing, and other symbolic representations of operations on data bits within a computer memory.

In the figures, a single block may be described as performing a function or functions. However, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, circuits, and steps have been described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example systems and devices may include components other than those shown, including well-known components such as a processor, memory, and the like.

Several aspects of transaction categorization using stacked machine learning layers will now be presented with reference to various apparatus and methods. These apparatus and methods will be described in the following detailed description and illustrated in the accompanying drawings by various blocks, components, circuits, devices, processes, algorithms, and the like (collectively referred to herein as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example implementations, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can include a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

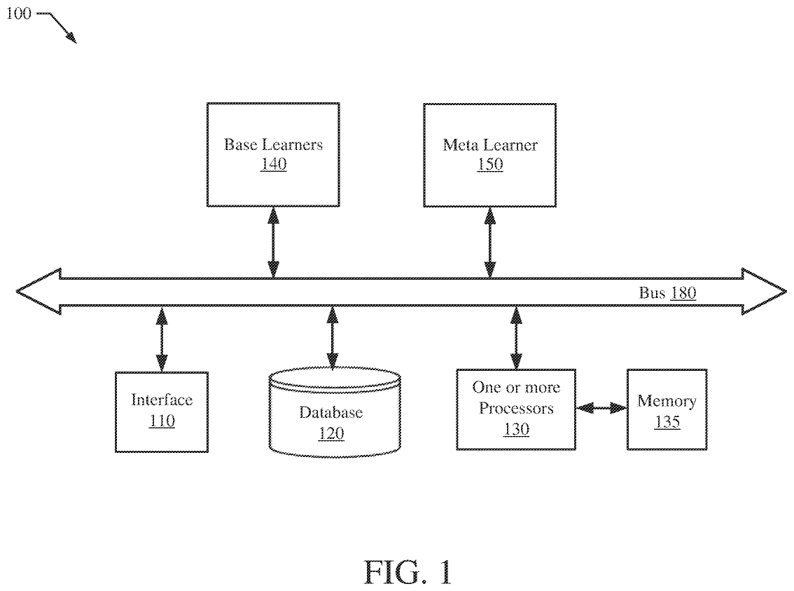

FIG. 1 shows a block diagram of a system 100 configured to categorize transactions based on stacked machine learning models including a plurality of base learners, a meta learner, and a confidence score model, according to some implementations. The system 100 is shown to include an input/output (I/O) interface 110, a database 120, one or more processors 130, a memory 135 coupled to the one or more processors 130, base learners 140, meta learner 150, and a data bus 180. The various components of the system 100 may be connected to one another by the data bus 180, as depicted in the example of FIG. 1. In other implementations, the various components of the system 100 may be connected to one another using other suitable signal routing resources.

The interface 110 may include any suitable devices or components to obtain information (such as input data) to the system 100 and/or to provide information (such as output data) from the system 100. In some instances, the interface 110 may include a display and an input device (such as a mouse and keyboard) that allows a person to interface with the system 100 in a convenient manner. For example, the interface 110 may enable obtaining a dataset comprising transaction data, which may be, e.g., labeled data, used for training data for the base learners 140 (and meta learner 150) or may be raw data for categorization by a trained base learners 140 (and trained meta learner 150). The dataset may be collected, for example, from one or more sources, such as from institutions and/or one or more users. Additionally or alternatively, the interface 110 may include an ethernet port, wireless interface, or other means to communicate with one or more other devices via wires or wirelessly. In some implementations, the system 100 may host an application for analysis of categorized transactions, e.g., for risk analysis or other type of analysis, or may provide the final inference results and associated final confidences to one or more such applications via the interface 110.

The base learners 140 and meta learner 150 may be implemented as one or more special purpose processors, which may be implemented separately or as part of the one or more processors 130. For example, the one or more processors 130 may execute instructions stored in memory 135, which configure the one or more processors 130 to perform one or more functions described herein. In the context of this particular specification, the one or more processors 130 may be a general purpose computer that once programmed pursuant to instructions stored in memory operates as a special purpose computer. The base learners 140 and meta learner 150 are illustrated separately from the one or more processors 130 for clarity.

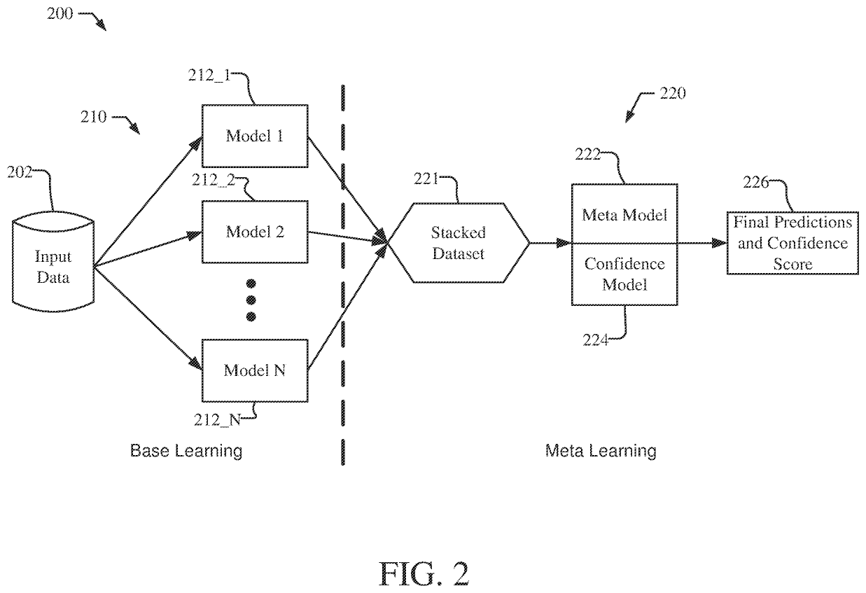

FIG. 2 shows an illustrative architecture of a framework 200 for model stacking including a plurality of base learners, a meta learner, and a confidence score model, according to some implementations. The framework 200, for example, may be implemented by the system 100 using base learners 140 and meta learner 150, and database 120.

As illustrated, a base learning layer 210 includes a plurality of base learning models, illustrated as Model 1 212_1, Model 2 212_2, and Model N 212_N, sometimes collectively referred to as base learner models 212. The base learner models 212 receive input data 202, which may be stored in database 120 shown in FIG. 1. The input data 202, for example, may be labeled transaction data used as training data and testing data, for training and testing the base learner models 212 (and by extension the meta learner model 222 in the meta learning layer 220), or may be acquired raw transaction data to be categorized by base learner models 212 (and meta learner model 222) once trained. Base learner models 212 are complementary machine learning models, with each model being associated with a different part of the dataset. There may be some overlap in associated parts of the complementary base learner models 212, but each base learner model 212 has a higher accuracy in its associated part than the remaining models in the base learning layer 210. For example, parts of the dataset may include areas such as a user's history of categorizing a transaction entity, a user's history of categorizing similar transaction entities, other user's history of categorizing transaction entity, embedded textual and/or numerical fields, etc. The base learner models 212, for example, may be one or more recommender based models and one or more neural network based classification models. In some implementations, the base learner models 212 may additionally or alternatively include one or more tree based models. Once trained, the base learner models 212 receive input data 202 and each base learner model 212 generates its own inference results and an associated measures of inference confidence.

The inference results and the associated measures of inference confidence from each of the base learner models 212 is collected in a stacked dataset 221, which may be stored in memory 135 or database 120 shown in FIG. 1. The stacked dataset 221 from the plurality of base machine learning models is a meta dataset used by the meta learning layer 220. The meta learning layer 220 includes a meta machine learning model 222, sometimes referred to as a meta learner model 222 and a confidence score model 224. The meta learner model 222 may be trained using a training stacked dataset 221, e.g., including training prediction results produced by each of the base learner models 212 from labeled training input data 202. The meta learner model 222, for example, may be a tree based model, such as a boosting tree machine learning model, or a random forest machine learning model, or other similar types of models. Similarly, the confidence score model 224 may be trained using the training stacked dataset 221, e.g., including measures of prediction confidences produced by each of the base learner models 212 from labeled training input data 202. The confidence score model 224, for example, may be a binary classification model trained to generate confidence scores by combining heterogeneous measures of prediction confidences stored in the stacked dataset 221 from the plurality of base learner models 212. Once trained, the meta learner model 222 and confidence score model 224 produce the final predictions, e.g., inference results, and associated final confidence score 226, which may be stored in memory 135 or database 120 shown in FIG. 1, and reported for assessment as desired.

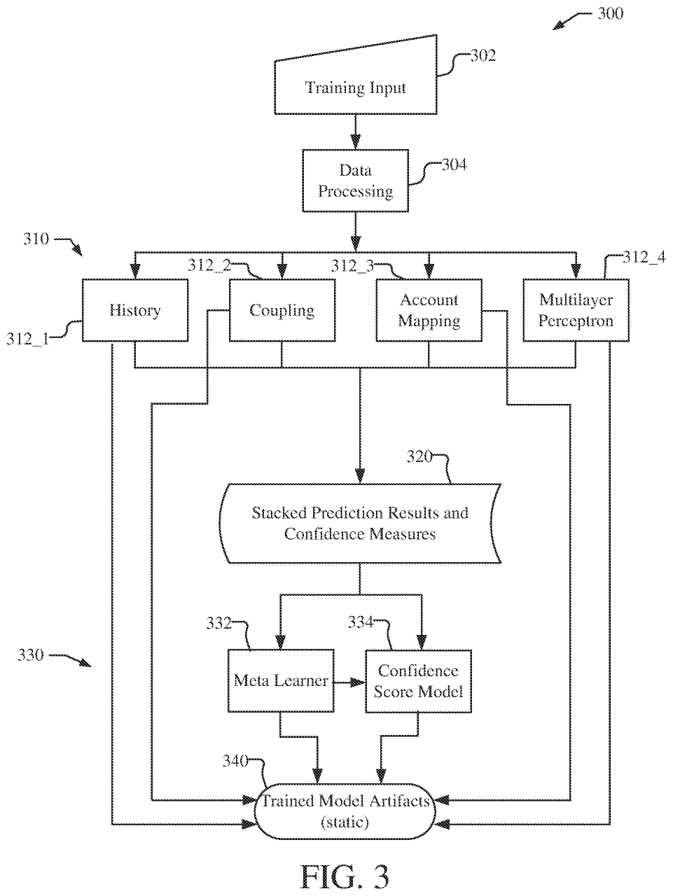

FIG. 3 shows an illustrative process 300 for offline training of the plurality of base learners, meta learner, and a confidence score model, according to some implementations. The process 300, for example, may use the system framework 200 shown in FIG. 2, and may be implemented by the system 100 using base learners 140 and meta learner 150, and database 120 in FIG. 1.

As illustrated, a training dataset is obtained by acquiring training input data (302). The training input data includes training transaction data, e.g., labeled transaction data. The training input data may be obtained, e.g., based on acquired transaction data and/or synthetic transaction data. The training input data, for example, may be acquired from multiple sources, such as from one or more institutions, one or more users, account information, etc. Users, for example, may provide suggested labels for the transaction information, which may be combined with transaction information from other sources to produce the training input data. In some implementations, the training input data may be processed (304), e.g., to remove noise or to modify inaccurate labels of the data to produce a training dataset.

The training dataset is provided to each of the plurality of complementary machine learning models (e.g., base learner models 212) for training (310). The plurality of complementary machine learning models, for example, may include one or more recommender based models and one or more neural network based classification models. Additional or different models may be used if desired. Each machine learning model in the plurality of complementary machine learning models is trained to infer prediction results and an associated measure of prediction confidence, which is collected as a meta training dataset 320.

Each of the machine learning models is associated with a different part of the training dataset and has a higher accuracy in an associated part than the other machine learning models. By way of example, as illustrated in FIG. 3, four base learner models (sometimes collectively referred to as base learner models 312) may be used to provide desired coverage of different parts of the training dataset. The base learner models, for example, may include a history based learner model (312_1), a coupling based learner model (312_2), a transaction account type mapping learner model (312_3), and a multilayer perceptron learner model (312_4). Other or different base learner models 312 may be used, or additional or fewer base learner models 312 (e.g., two or more) may be used, if desired, and may be selected based on the type of transaction data being categorized, e.g., to provide desired coverage with desired accuracy of the dataset with the collection of complimentary base learner models 312.

The history based learner model 312_1, for example, may be a recommender based model that is trained to infer prediction results and to measure of the prediction confidence based on recency or frequency of a categorization of transactions by a user for a same transaction entity. For example, the history based learner model 312_1 may be trained such that for a new transaction, it looks for how the same entity, e.g., the same user, classified the same transaction in the past. The same transaction, for example, may be based on transaction entity and/or transaction amount considered by the system. For example, using a transaction amount sign, e.g., “−” or “+”) and transaction description may be sufficient to represent such an entity (e.g., a transaction with description of “XYZ Co.” and the amount of −$20 may be represented as ‘XYZ Co.’). The transaction description may have a high cardinality, and in order to create matched transaction entities, a set of regular expressions may be employed to largely reduce its cardinality. The history based learner model 312_1 may be trained to determine ranking of the predicted category based on how recently the same entity classified the same transaction or how frequently the same entity classified the same transaction. For example, the top two most frequency assigned categories for the transaction may be ranked. The history based learner model 312_1 is further trained to measure the confidence based on how long since the entity categorized the same transaction in the past or how many times the entity categorized the same transaction.

The coupling based learner model 312_2, for example, may be a recommender based model that is trained to infer the prediction results and the measure of the prediction confidence based on categorization of transactions by a user for similar transaction entities. For example, the coupling based learner model 312_2 may be trained such that for a new transaction, it looks for how the same entity, e.g., the same user, classified the similar transactions in the past.

The similarity of transactions, for example, may be calculated using Kulczynski similarity index or Jaccard index. By way of example, Jaccard index is a statistic for determining the similarity and diversity of sample sets based on the size of the intersection divided by the size of the union of sample sets. For example, \vec{T}ᵢ is the vector that represents the Jaccard index of transaction i with all other transactions, e.g., \vec{T}ᵢ=(J₁ᵢ, J₂ᵢ, . . . , Jᵢᵢ, . . . , Jₙᵢ), i=1, 2, . . . , n, where the Jaccard index Jᵢⱼ, between the transactions t at indices i and index j, i.e., tᵢ and tdj, may be written as:

$${J}_{ij} = J ( {t}_{i} , {t}_{j} ) = \frac{\vert {t}_{i} ⋂ {t}_{j} \vert}{\vert {t}_{i} ⋃ {t}_{j} \vert} = \frac{\vert {t}_{i} ⋂ {t}_{j} \vert}{\vert {t}_{i} \vert + \vert {t}_{j} \vert - \vert {t}_{i} ⋂ {t}_{j} \vert} \qquad eq . 1$$

$$0 \leq {J}_{ij} \leq 1$$

In equation 1, |tᵢ| is the number of accounts that contain tᵢ. Thus, the pairwise similarity matrix or co-occurrence matrix is generated. It is noted that (\vec{T}₁, \vec{T}₂, . . . , \vec{T}ₙ)^{T} is a very sparse matrix, e.g., although there may be more than 10M distinct transaction entities, the matrix is far less than 10M×10M elements. Expanding on this example, with 10M distinct transaction entities, there may be only approximately 1B non-zero elements, and thus storing it as a sparse matrix is computationally efficient. In the inference time, the coupling based learner model 312_2 may compute a normalized sum of all the similarity scores for each account category. For example, given a transaction t from a user k, for every account a, which had a transaction history, the normalized sum of all the similarity scores (Jₐ_{ᵢ}) for each account may be calculated as:

$${J}_{{a}_{i}} = {\sum }_{m \neq t} {\hat{J}}_{tm} . \qquad eq . 2$$

The coupling based learner model 312_2 may then choose the account type with the largest value, e.g.,

$$a = {arg max}_{{a}_{i}} ( {J}_{{a}_{i}} ) . \qquad eq . 3$$

In some implementations, the top three assigned categories may be ranked. Additionally, the coupling based learner model 312_2 may be trained to calculate the confidence measure as the normalized sum of the similarity index.

The transaction type mapping machine learning model 312_3, for example, may be a recommender based model that is trained to infer the prediction results and the measure of the prediction confidence based on categorization of transactions by all users for the same transaction entity. In other words, transaction type mapping machine learning model 312_3 may be trained on the entire user population based on how all users collectively categorize the same transaction entity. The transaction type mapping machine learning model 312_3 may be trained to determine the confidence measure based on the relative frequency of how the predicted category is categorized by all users.

The multilayer perceptron learner model 312_4, for example, may be one or more neural network based classification models trained to infer the prediction results and measure of the prediction confidence based on one-hot encoding or embedding encoded categorical and text fields together with numerical fields, and the prediction result and the measure of the prediction confidence may be a vector of predicted category probability distribution. The multilayer perceptron learner model 312_4, for example, may be trained with a final softmax layer that produces a vector output of predicted category probability distribution, which may also be used as the confidence measure vector.

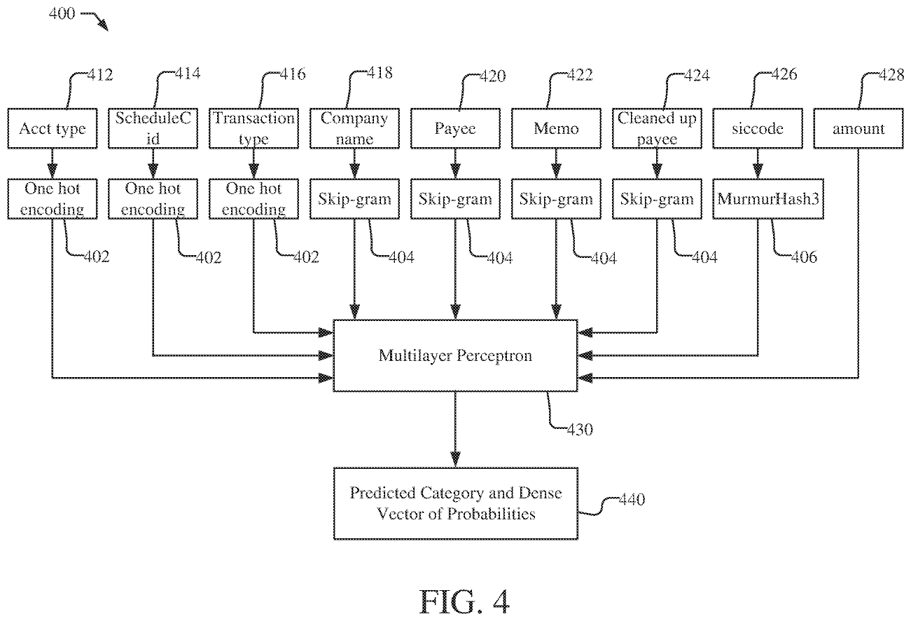

FIG. 4, by way of example, illustrates an example of a multilayer perceptron model 400, which may be used as multilayer perceptron learner model 312_4 shown in FIG. 3. As illustrated, the multilayer perceptron model 400 that may employ one hot encoding 402 with input data, such as account type 412, schedule id 414 and transaction type 416, and may employ skip-gram 404 with input data, such as company name 418, payee 420, memo 422, and cleaned up payee 424. The multilayer perceptron model 400 may further use murmurHash3 406 with input data, such as Standard Industrial Classification code (siccode) 426, and may use numerical fields for input data, such as amount 428. It should be understood that FIG. 4 merely illustrates possible input data, and that additional, less or different input data may be used and additional, fewer or other function types may be used with input data. The encoded categorical fields, text fields, and numerical fields output from the one hot encoding 402, skip-gram 404, murmurhash 406, and input data such as amount 428, is received by the multilayer perceptron model 430, which may employ a softmax function, which outputs predicted category and dense vector of probabilities 440.

Referring back to FIG. 3, the prediction results and associated confidence measures output from each of the complementary base learner models 312 is collected as a stacked dataset, which serves as the meta training dataset (320). Additionally, the trained model artifacts, e.g., trained model parameters such as weights and biases, from each of the complementary base learner models 312 is stored (340).

The prediction results and associated confidence measures in the meta training dataset are provided for training (330) of the meta learner model (332) and the confidence score model (334), after vector concatenation. The meta learner model 332 is trained with the meta training dataset obtained from the base learner models 312 to infer final prediction results. The meta training dataset only contains the results from the base learning step 310, which are all predicted categories and numerical measures of base learning confidence. Accordingly, the meta learner model 332 may be, e.g., a boosting tree machine learning model, such as the Light Gradient Boosting Machine (LightGBM), to yield highly accurate prediction results.

The confidence score model 334 is trained based on the meta training dataset and the final prediction results from the meta learning model 332 to generate measures of final prediction confidences associated with the final prediction results. The confidence score model 334, for example, may be a binary classification model that is trained to generate confidence scores by combining heterogeneous measures of prediction confidences in the meta training dataset. The final confidence score is to measure the trustworthiness of the final prediction results from the meta learner model 332. The final confidence score, for example, may be used to sort the final prediction results for further evaluation. For example, it may be useful for evaluation of the final prediction results to focus on those that are least confident, thus an important property of the confidence score is to ensure the fraction of correct predictions above a certain confidence score is monotonically increasing with respect to the ascending confidence score. With the final prediction result from the meta learner model 332, a learning dataset may be constructed with labels being whether the final prediction result is the same as the ground truth (1) or not (0), with the features used to train the confidence score model 334 being from the confidence measures from the base learner models 312, e.g., in the meta training dataset. The confidence score model 334 for the final confidence measure may be framed as a binary classification model and its output probability is used as the final confidence score.

The trained model artifacts, e.g., weights and biases or other trained model parameters, from the meta learner model 332 and the confidence score model 334 are stored (340), e.g., in memory 135 or database 120 shown in FIG. 1, along with the training model artifacts, e.g., weights and biases or other trained model parameters, from the complementary base learner models 312.

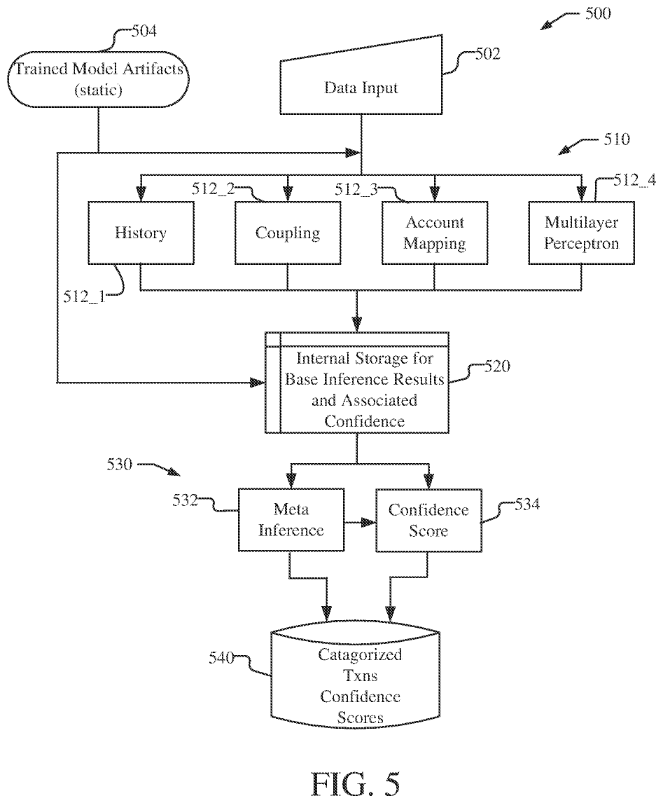

FIG. 5 shows an illustrative process 500 for inference using stacked models including the plurality of base learners, the meta learner, and the confidence score model, according to some implementations. The process 500, for example, may use the system framework 200 shown in FIG. 2 that is trained according to the process 300 shown in FIG. 3, and may be implemented by the system 100 using base learners 140 and meta learner 150, and database 120 in FIG. 1.

As illustrated, a dataset is acquired and provided as data input (502) for the base learner models. By way of example, the dataset may be a set of transactions to be categorized. The dataset may be acquired via the interface 110 shown in FIG. 1. In some implementations, the dataset may be a full dataset to be categorized, while in other implementations, the dataset may be an incremental dataset, e.g., which may be generated by obtaining a new dataset and determining the incremental changes in the new dataset with respect to one or more previously acquired datasets.

The dataset is provided as data input to each of the plurality of complementary machine learning models (e.g., base learner models 512) in the base layer inference (510). Additionally, trained model artifacts (504), e.g., corresponding to the stored trained model artifacts 340 for the base learner models 312 discussed in reference to FIG. 3, may be provided to the base learner models 512.

The base learner models 512 may include one or more recommender based models and one or more neural network based classification models. For example, the base learner models 512 may be the same as the base learner models 312, discussed in reference to FIGS. 3 and 4, that are trained, e.g., with the weights and biases or other trained model parameters of the trained model artifacts 504. Thus, the base learner models 512 are complimentary with each associated with a different part of the dataset and having a higher accuracy in an associated part than the other base learner models. For example, the base learner models 512 may include a history based learner model (512_1), a coupling based learner model (512_2), a transaction account type mapping learner model (512_3), and a multilayer perceptron learner model (512_4), which may correspond to respective base learner models 312_1, 312_2, 312_3, and 312_4. Other or different base learner models 512 may be used or additional or fewer base learner models 512 (e.g., two or more) may be used, if desired, which may be selected based on the type of transaction data being categorized, e.g. so that all desired parts of the dataset are accurately covered by the collection of complimentary base learner models 512.

As discussed in reference to FIGS. 2-4, the base learner models 512 may include one or more recommender based models and one or more neural network based classification models. Each machine learning model in the plurality of complementary machine learning models is trained to infer prediction results and an associated measure of prediction confidence. The inference results and associated measures of inference confidences output from each of the complementary base learner models 512 are collected as a meta dataset and stored in internal storage (520), e.g., in memory 135 or database 120 shown in FIG. 1. Additionally, the trained model artifacts (504), e.g., for the stored trained model artifacts 340 for the meta learner model 330 discussed in reference to FIG. 3, may be stored in internal storage 520.

The meta dataset is provided as data input to the meta learner model (532) and the confidence score model (534) in the meta base layer inference (530). Additionally, the trained model artifacts (504), e.g., corresponding to the stored trained model artifacts 340 for the base learner models 312 discussed in reference to FIG. 3, may be provided to the meta learner model 532 and the confidence score model 534.

The meta learner model 532 may be the same as the meta learner model 332, discussed in reference to FIG. 3, that is trained, e.g., with the weights and biases or other trained model parameters of the trained model artifacts 504. The trained meta learner model 532 generates final inference results, e.g., with categorized transactions, based on the meta dataset. The meta learner model 532, for example, may be a boosting tree machine learning model. The confidence score model 534 may be the same as the confidence score model 334 discussed in reference to FIG. 3, that is trained, e.g., with the weights and biases or other trained model parameters of the trained model artifacts 504. The confidence score model 534 generates final confidences associated with the final inference results based on the meta dataset and the final inference results. The confidence score model 534, for example, may be a binary classification model that is trained to combine heterogeneous measures of prediction confidences to generate the final confidence scores.

The final inference results and associated final confidences from the meta learner model 532 and the confidence score model 534, respectively, are reported, e.g., provided to and stored in a database (540), e.g., in memory 135 or database 120 shown in FIG. 1. The final inference results, e.g., categorized transactions, and associated confidence scores may be further provided to an application on the same system, e.g., system 100 shown in FIG. 1, or an external application for desired analysis, such as risk analysis or other type of analysis.

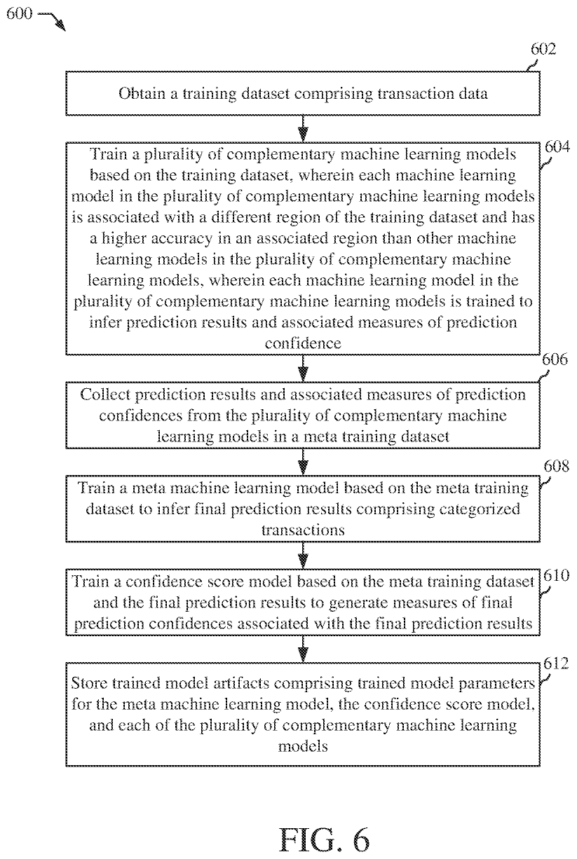

FIG. 6 shows an illustrative flowchart depicting an example operation 600 for training stacked machine learning models, according to some implementations. The example operation 600 is described as being performed by the system 100, such as by the one or more processors 130 executing instructions to perform operations associated with the components 140 and 150 shown in FIG. 1 and described in reference to framework 200 and process 300 shown in FIGS. 2 and 3.

At block 602, a training dataset that includes transaction data is obtained, e.g., as discussed in reference to blocks 302 and 304 in FIG. 3.

At block 604, a plurality of complementary machine learning models is trained based on the training dataset, e.g., as discussed in reference to step 310 and blocks 312_1, 312_2, 312_3, and 312_4 of FIG. 3 and in reference to FIG. 4. For example, as discussed in reference to FIGS. 2 and 3, each machine learning model in the plurality of complementary machine learning models is associated with a different part of the training dataset and has a higher accuracy in an associated part than other machine learning models in the plurality of complementary machine learning models. Further, as discussed in reference to FIGS. 2 and 3, each machine learning model in the plurality of complementary machine learning models is trained to infer prediction results and associated measures of prediction confidence.

At block 606, prediction results and associated measures of prediction confidences are collected from the plurality of complementary machine learning models in a meta training dataset, e.g., as discussed in reference to block 320 in FIG. 3.

At block 608, a meta machine learning model is trained based on the meta training dataset to infer final prediction results comprising categorized transactions, e.g., as discussed in reference to step 330 and block 332 of FIG. 3.

At block 610, a confidence score model is trained based on the meta training dataset and the final prediction results to generate measures of final prediction confidences associated with the final prediction results, e.g., as discussed in reference to step 330 and block 334 of FIG. 3.

At block 612, trained model artifacts are stored, e.g., as discussed in reference to block 340 in FIG. 3. The trained model artifacts, for example, may include the trained model parameters, such as weights and biases, for the meta machine learning model and the confidence score model and each of the plurality of complementary machine learning models.

In some implementations, the plurality of complementary machine learning models may include one or more recommender based models and one or more neural network based classification models, e.g., as discussed in reference to step 310 and blocks 312_1, 312_2, 312_3, and 312_4 of FIG. 3.

In some implementations, for example, one machine learning model in the plurality of complementary machine learning models may be a history machine learning model that is trained to infer the prediction results and the associated measures of the prediction confidence based on recency or frequency of a categorization of transactions by a user for same transaction entity, e.g., as discussed in reference to step 310 and block 312_1 of FIG. 3.

In some implementations, for example, one machine learning model in the plurality of complementary machine learning models may be a coupling machine learning model that is trained to infer the prediction results and the associated measures of the prediction confidence based on categorization of transactions by a user for similar transaction entities, e.g., as discussed in reference to step 310 and block 312_2 of FIG. 3.

In some implementations, for example, one machine learning model in the plurality of complementary machine learning models may be a transaction type mapping machine learning model that is trained to infer the prediction results and the associated measures of the prediction confidence based on categorization of transactions by a plurality of users for the same transaction entity, e.g., as discussed in reference to step 310 and block 312_3 of FIG. 3.

In some implementations, for example, one machine learning model in the plurality of complementary machine learning models may be a multilayer perceptron model trained to infer the prediction results and associated measures of the prediction confidence based on encoded categorical fields, text fields, and numerical fields, in which the prediction results and the associated measures of the prediction confidence are vectors of predicted category probability distribution, e.g., as discussed in reference to step 310 and block 312_4 of FIG. 3 and in reference to FIG. 4.

In some implementations, the meta machine learning model may be a boosting tree machine learning model, e.g., as discussed in reference to step 330 and block 332 of FIG. 3.

In some implementations, the confidence score model may be a binary classification model trained to generate confidence scores by combining heterogeneous measures of prediction confidences from the plurality of complementary machine learning models in the meta training dataset, e.g., as discussed in reference to step 330 and block 334 of FIG. 3.

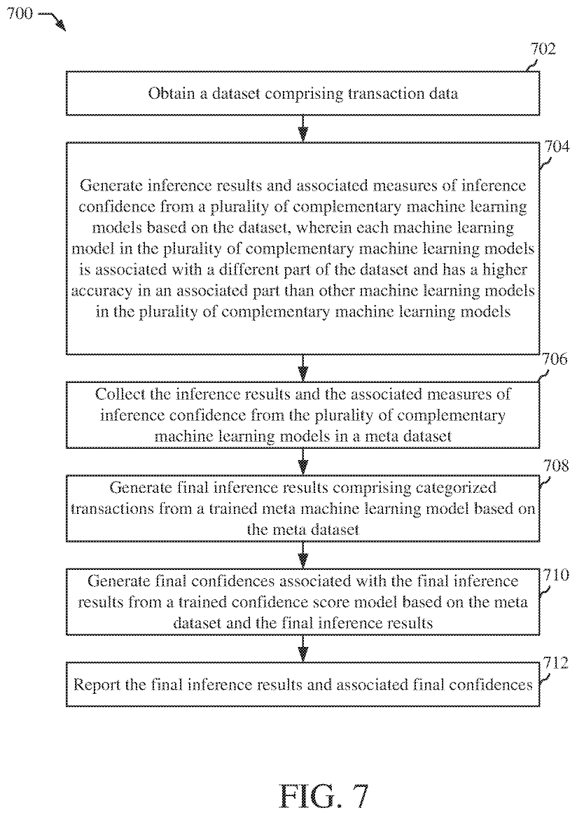

FIG. 7 shows an illustrative flowchart depicting an example operation 700 for inference using stacked machine learning models, according to some implementations. The example operation 700 is described as being performed by the system 100, such as by the one or more processors 130 executing instructions to perform operations associated with the components 140 and 150 shown in FIG. 1 and described in reference to framework 200 and process 500 shown in FIGS. 2 and 5.

At block 702, a dataset including transaction data is obtained, e.g., as discussed in reference to block 502 in FIG. 5.

At block 704, inference results and associated measures of inference confidence are generated from a plurality of complementary machine learning models based on the dataset, e.g., as discussed in reference to step 510 and blocks 512_1, 512_2, 512_3, and 512_4 of FIG. 5. For example, as discussed in reference to FIGS. 2 and 5, each machine learning model in the plurality of complementary machine learning models may be associated with a different part of the dataset and has a higher accuracy in an associated part than other machine learning models in the plurality of complementary machine learning models.

At block 706, the inference results and the associated measures of inference confidence are collected from the plurality of complementary machine learning models in a meta dataset, e.g., as discussed in reference to block 520 in FIG. 5.

At block 708, final inference results including categorized transactions are generated from a trained meta machine learning model based on the meta dataset, e.g., as discussed in reference to step 530 and block 532 of FIG. 5.

At block 710, final confidences associated with the final inference results are generated from a trained confidence score model based on the meta dataset and the final inference results, e.g., as discussed in reference to step 530 and block 534 of FIG. 5.

At block 712, the final inference results and associated final confidences are reported, e.g., as discussed in reference to block 540 of FIG. 5.

In one implementation, the transaction data may be incremental transactions, and the dataset including the transaction data may be obtained by obtaining a set of transactions, and determining incremental transactions based on the set of transactions relative to previous sets of transactions, in which the transaction data comprises the incremental transactions, e.g., as discussed in reference to block 502 of FIG. 5.

In one implementation, the plurality of complementary machine learning models comprises one or more recommender based models and one or more neural network based classification models, e.g., as discussed in reference to step 510 and blocks 512_1, 512_2, 512_3, and 512_4 of FIG. 5.

In one implementation, one machine learning model in the plurality of complementary machine learning models may be a history machine learning model that is trained to generate the inference results and the associated measures of the inference confidence based on recency or frequency of a categorization of transactions by a user for same transaction entity, e.g., as discussed in reference to step 510 and block 512_1 of FIG. 5 and in reference to step 310 and block 312_1 of FIG. 3.

In one implementation, one machine learning model in the plurality of complementary machine learning models may be a coupling machine learning model that is trained to generate the inference results and the associated measures of the inference confidence based on categorization of transactions by a user for similar transaction entities, e.g., as discussed in reference to step 510 and block 512_2 of FIG. 5 and in reference to step 310 and block 312_2 of FIG. 3.

In one implementation, one machine learning model in the plurality of complementary machine learning models may be a transaction type mapping machine learning model that is trained to generate the inference results and the associated measures of the inference confidence based on categorization of transactions by a plurality of users for a same transaction entity, e.g., as discussed in reference to step 510 and block 512_3 of FIG. 5 and in reference to step 310 and block 312_3 of FIG. 3.

In one implementation, one machine learning model in the plurality of complementary machine learning models may be a multilayer perceptron model trained to generate the inference results and the associated measures of the inference confidence based on categorical fields, text fields, and numerical fields, in which the inference results and the associated measures of the prediction confidence are vectors of inferred category probability distribution, e.g., as discussed in reference to step 510 and block 512_4 of FIG. 5 and in reference to step 310 and block 312_4 of FIG. 3 and FIG. 4.

In one implementation, the trained meta machine learning model may be a boosting tree machine learning model, e.g., as discussed in reference to step 530 and block 532 of FIG. 5.

In one implementation, the trained confidence score model may be a binary classification model trained to generate confidence scores by combining heterogeneous measures of prediction confidences from the plurality of complementary machine learning models in the meta dataset, e.g., as discussed in reference to step 530 and block 534 of FIG. 5.

As used herein, a phrase referring to “at least one of” a list of items refers to any combination of those items, including single members. As an example, “at least one of: a, b, or c” is intended to cover: a, b, c, a-b, a-c, b-c, and a-b-c.

Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The various illustrative logics, logical blocks, modules, circuits, and algorithm processes described in connection with the implementations disclosed herein may be implemented as electronic hardware, computer software, or combinations of both. The interchangeability of hardware and software has been described generally in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor or any conventional processor, controller, microcontroller, or state machine. A processor also may be implemented as a combination of computing devices such as, for example, a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

1. A computer-implemented method, comprising:
receiving a dataset comprising transaction data at a computer system;
generating both inference results and associated measures of inference confidence from a plurality of complementary machine learning models based on the dataset, wherein each machine learning model in the plurality of complementary machine learning models is associated with a different part of the dataset and has a higher accuracy in an associated part than other machine learning models in the plurality of complementary machine learning models;
storing both the inference results and the associated measures of inference confidence from the plurality of complementary machine learning models in a meta dataset in memory of the computer system;
generating final inference results comprising categorized transactions from a trained meta machine learning model based on the meta dataset;
generating final confidences associated with the final inference results from a trained confidence score model based on the associated measures of inference confidence in the meta dataset and the final inference results; and
providing the final inference results and associated final confidences by the computer system to an application.

2. The computer-implemented method of claim 1, wherein receiving the dataset comprising the transaction data at the computer system comprises:
receiving a set of transactions at the computer system; and
determining incremental transactions based on the set of transactions relative to previous sets of transactions, wherein the transaction data comprises the incremental transactions.

3. The computer-implemented method of claim 1, wherein one machine learning model in the plurality of complementary machine learning models comprises a history machine learning model that is trained to generate the inference results and the associated measures of the inference confidence based on recency or frequency of a categorization of transactions by a user for a same transaction entity.

4. The computer-implemented method of claim 1, wherein one machine learning model in the plurality of complementary machine learning models comprises a coupling machine learning model that is trained to generate the inference results and the associated measures of the inference confidence based on categorization of transactions by a user for a different of transaction entity.

5. The computer-implemented method of claim 1, wherein one machine learning model in the plurality of complementary machine learning models comprises a transaction type mapping machine learning model that is trained to generate the inference results and the associated measures of the inference confidence based on categorization of transactions by a plurality of users for a same transaction entity.

6. The computer-implemented method of claim 1, wherein one machine learning model in the plurality of complementary machine learning models comprises a multilayer perceptron model trained to generate the inference results and the associated measures of the inference confidence based on categorical fields, text fields, and numerical fields, wherein the inference results and the associated measures of the inference confidence are vectors of inferred category probability distribution.

7. The computer-implemented method of claim 1, wherein the plurality of complementary machine learning models comprises one or more recommender based models and one or more neural network based classification models, the trained meta machine learning model comprises a boosting tree machine learning model, and the trained confidence score model is a binary classification model trained to generate confidence scores by combining heterogeneous measures of inference confidence from the plurality of complementary machine learning models in the meta dataset.

8. A system for categorizing transactions, comprising:
an interface through which a dataset is obtained;
one or more processors; and
a memory coupled to the one or more processors and the interface and storing instructions that, when executed by the one or more processors, cause the system to perform operations comprising:
receive a dataset comprising transaction data at the one or more processors through the interface;
generate both inference results and associated measures of inference confidence from a plurality of complementary machine learning models based on the dataset, wherein each machine learning model in the plurality of complementary machine learning models is associated with a different part of the dataset and has a higher accuracy in an associated part than other machine learning models in the plurality of complementary machine learning models;
store both the inference results and the associated measures of inference confidence from the plurality of complementary machine learning models in a meta dataset in the memory;
generate final inference results comprising categorized transactions from a trained meta machine learning model based on the meta dataset;
generate final confidences associated with the final inference results from a trained confidence score model based on the associated measures of inference confidence in the meta dataset and the final inference results; and
provide the final inference results and associated final confidences through the interface to an application.

9. The system of claim 8, wherein the system is caused to receive the dataset by being caused to perform operations comprising:
receive a set of transactions at the one or more processors through the interface; and
determine incremental transactions based on the set of transactions relative to previous sets of transactions, wherein the transaction data comprises the incremental transactions.

10. The system of claim 8, wherein one machine learning model in the plurality of complementary machine learning models comprises a history machine learning model that is trained to generate the inference results and the associated measures of the inference confidence based on recency or frequency of a categorization of transactions by a user for a same transaction entity.

11. The system of claim 8, wherein one machine learning model in the plurality of complementary machine learning models comprises a coupling machine learning model that is trained to generate the inference results and the associated measures of the inference confidence based on categorization of transactions by a user for a different ef transaction entity.

12. The system of claim 8, wherein one machine learning model in the plurality of complementary machine learning models comprises a transaction type mapping machine learning model that is trained to generate the inference results and the associated measures of the inference confidence based on categorization of transactions by a plurality of users for a same transaction entity.

13. The system of claim 8, wherein one machine learning model in the plurality of complementary machine learning models comprises a multilayer perceptron model trained to generate the inference results and the associated measures of the inference confidence based on categorical fields, text fields, and numerical fields, wherein the inference results and the associated measures of the inference confidence are vectors of inferred category probability distribution.

14. The system of claim 8, wherein the plurality of complementary machine learning models comprises one or more recommender based models and one or more neural network based classification models, the trained meta machine learning model comprises a boosting tree machine learning model, and the trained confidence score model is a binary classification model trained to generate confidence scores by combining heterogeneous measures of inference confidence from the plurality of complementary machine learning models in the meta dataset.

15. A computer-implemented method, comprising:
receiving a training dataset comprising transaction data at a computer system;
training a plurality of complementary machine learning models based on the training dataset, wherein each machine learning model in the plurality of complementary machine learning models is associated with a different part of the training dataset and has a higher accuracy in an associated part than other machine learning models in the plurality of complementary machine learning models, wherein each machine learning model in the plurality of complementary machine learning models is trained to infer both prediction results and associated measures of prediction confidence;
storing both prediction results and associated measures of prediction confidences from the plurality of complementary machine learning models in a meta training dataset in memory of the computer system;
training a meta machine learning model based on the meta training dataset to infer final prediction results comprising categorized transactions;
training a confidence score model based on the associated measures of prediction confidences in the meta training dataset and the final prediction results to generate measures of final prediction confidences associated with the final prediction results; and
storing trained model artifacts comprising trained model parameters for the meta machine learning model, the confidence score model, and each of the plurality of complementary machine learning models.

16. The computer-implemented method of claim 15, wherein one machine learning model in the plurality of complementary machine learning models comprises a history machine learning model that is trained to infer the prediction results and the associated measures of the prediction confidence based on recency or frequency of a categorization of transactions by a user for a same transaction entity.

17. The computer-implemented method of claim 15, wherein one machine learning model in the plurality of complementary machine learning models comprises a coupling machine learning model that is trained to infer the prediction results and the associated measures of the prediction confidence based on categorization of transactions by a user for a different of transaction entity.

18. The computer-implemented method of claim 15, wherein one machine learning model in the plurality of complementary machine learning models comprises a transaction type mapping machine learning model that is trained to infer the prediction results and the associated measures of the prediction confidence based on categorization of transactions by a plurality of users for a same transaction entity.

19. The computer-implemented method of claim 15, wherein one machine learning model in the plurality of complementary machine learning models comprises a multilayer perceptron model trained to infer the prediction results and associated measures of the prediction confidence based on encoded categorical fields, text fields, and numerical fields, wherein the prediction results and the associated measures of the prediction confidence are vectors of predicted category probability distribution.

20. The computer-implemented method of claim 15, wherein the plurality of complementary machine learning models comprises one or more recommender based models and one or more neural network based classification models, the meta machine learning model comprises a boosting tree machine learning model and the confidence score model is a binary classification model trained to generate confidence scores by combining heterogeneous measures of prediction confidences from the plurality of complementary machine learning models in the meta training dataset.
